(19) United States
(12) Patent Application Publication
(10) Pub. No.: US 2011/0254192 A1
(43) Pub. Date: Oct. 20, 2011

(54) Structural Components fabricated from waste materials and method of making same

(76) Inventor: Joseph Alfred Leon, Bakersfield, CA (US)

(21) Appl. No.: 12/763,546

(22) Filed: Apr. 20, 2010

(51) Int. Cl. B29C 47/02; B32B 5/16

(52) U.S. Cl. 264/152; 428/53

(57) ABSTRACT

The structural component and fabrication to form a cable, cords or other structural component may be formed by mechanically cutting, waste-reinforced used tires, waste-reinforced used fan belts, waste-reinforced used conveyor belts into strips and attaching them end to end with metal staples or a bonding agent to create a reinforced rubber cable or cord. To be used as structural strength when encapsulated with virgin and or recycled thermoplastics, or rubber. Said strips would be used as reinforcement in concrete, cement, adobe or asphalt. The process when used with thermoplastics or rubber will incorporate an extruder to obtain a molten state of the thermoplastics or rubber to form the structural component thru a crosshead die or molds for injection molding. The process when using concrete, cement, adobe or asphalt to create a structural component will use the waste-reinforced rubber strips placed into forms, or molds for reinforcement when drying has occurred. The strips from the sidewalls of reinforced tires can be used as tie-down cords with “S” hooks or other attachment devices. It is emphasized that this abstract is provided to comply with the rules requiring an abstract that will allow a search or other reader to quickly ascertain the subject matter of the technical disclosure. It is submitted with the understanding that it will not be used to interpret or limit the scope or meaning of the claims.

### BACKGROUND OF THE INVENTION

The present invention generally relates to the use of used steel belted tires, used fan belts or used conveyor belts, cut into long strips for the reinforcement element in the fabrication of structural members. Many reinforced structural components are used on a daily basis. For example, cables are used for securing an entrance into a parking lot; cables are also used in fencing. Cords are used to tie down items that would otherwise be loose. Driveways are poured every day with steel rebar or steel wire mesh used as reinforcement, now we can use cut steel belted tires into long strips to do the reinforcement at a tremendous savings to world society. Now we can manufacture reinforced plastic lumber with the steel belted tire strips or form a structural component that would be better off if it were manufactured with an affordable reinforcement. We all benefit when we recycle any item that takes away from our consumption of our natural resources. For example, waste used tires are costly to get rid of, and if left unchecked create breeding grounds for mosquitoes, rodents and other disease carrying critters. Waste used fan belts and waste used conveyor belts, when disposed of take up space in our valuable landfills. Waste plastic is in our oceans, streams, and rivers creating a real health hazard to our wildlife and mankind alike. When these waste items are used to create a structural component, we improve the integrity of the structural component; we also bury the waste items within said structural components.

By using this waste used steel belted tire strips as a reinforcement element in the construction of a structural component; we don't have to rely on costly new steel products for reinforcement. Many third world countries can't afford to pay for steel reinforcement in there structural components and when a natural disaster hits, buildings collapse, houses and lives are lost. Waste used steel belted tires are abundant through the world and the reinforcement element could be harvested from the same.

### SUMMARY OF THE INVENTION

The present invention may be directed to a structural component which may be manufactured from processing waste, used reinforced steel belted tires, waste used reinforced fan belts, waste used reinforced conveyor belts, along with waste thermoplastic, or virgin thermoplastic, rubber, concrete, cement, adobe, or asphalt to create a useful structural component. “S” hooks and or other attachment devices are used with the sidewall strips to create a useful tie downs. These waste reinforced elements, would otherwise be disposed of, which is expensive and difficult.

The present invention further comprises a method of producing the disclosed structural components for utility lines, railroads, pier construction, fence post, plant stakes, traffic highway dividers, temporary traffic dividers or K-rail, guard rail post, blocks, walls, erosion prevention railings, driveways, curb and gutters, foundations, asphalt roadways, cables, and tie down cords.

These and other features, aspects, and advantages of the present invention will become better understood with references to the following drawings, description and claims.

### LEGEND

A. The letter A refers to Waste Steel Belted Tire Strips, installed separate or woven together.
B. The letter B refers to Waste recycled thermoplastic or virgin thermoplastic.
C. The letter C refers to Waste recycled rubber or virgin rubber.
D. The letter D refers to Waste reinforced sidewall tire strips.
E. The letter E refers to Waste reinforced fan belt strips.
F. The letter F refers to Waste reinforced conveyor belt strips.
G. The letter G refers to Concrete.
H. The letter H refers to Cement
I. The letter I refers to Adobe
J. The letter J refers to Asphalt.
K. The letter K refers to metal “S” hooks or other attachment devices.
L. The letter L refers to steel eye bolt may be heavy duty rebar.
M. The letter M refers to steel anchor bolt, may be heavy duty rebar.
N. The letter N refers to Punched holes in the Waste tire sidewall strips.

### Explanation of Sample Components

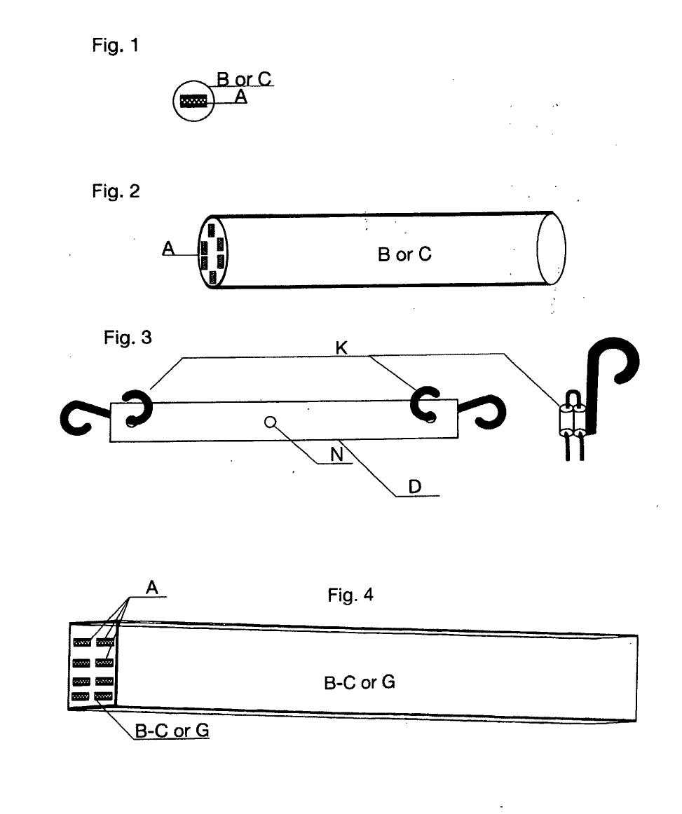

FIG. 1 shows the end view of a cable wherein the Waste reinforced steel belted tire strips are used as the core of a cable with a thermoplastic or rubber encapsulating said core materials.

FIG. 2 shows the side view of FIG. 1

FIG. 3 shows a side view of a Tire Tie, stretchable, made from the sidewalls of Waste reinforced tires. “S” hooks are used to show a typical attachment device. Other adjustable hooks could be used as illustrated in FIG. 3

FIG. 4 shows a end and side views of a rail road tie, wherein the core consist of Waste reinforced steel belted tire strips for reinforcement, and the remainder of the embodiment would consist of either Waste thermoplastic, virgin thermoplastic, or rubber, or concrete.

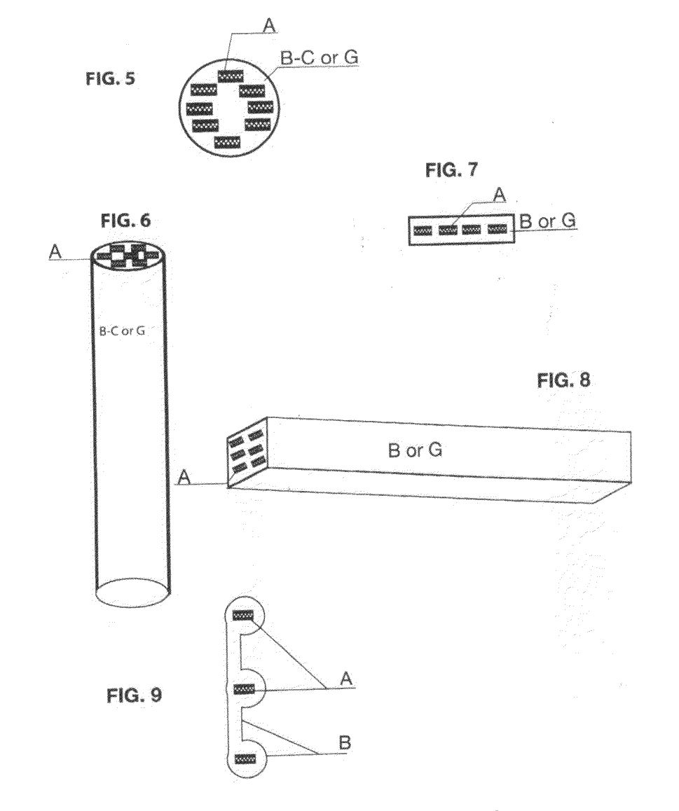

FIG. 5 shows an end view of a pole or post wherein the core is made up of Waste reinforced steel belted tire strips. Installed separate or woven together to become reinforcement and the remainder of the component would consist of either Waste thermoplastic or virgin plastic, or rubber, or concrete.

FIG. 6 shows a side view of FIG. 5 which could be round, square or different shapes, depending on the desired use.

FIG. 7 shows the end view of a typical board, wherein the core is made up from Waste reinforced steel belted tire strips and the remainder of the component is made up of Waste thermoplastic, or virgin thermoplastic, or concrete.

FIG. 8 shows a side view of FIG. 7

FIG. 9 shows an end view of a flexible fencing strip wherein the reinforcement is made from Waste reinforced steel belted tire strips, and the remainder of the component are made from Waste recycled thermoplastic or virgin thermoplastic.

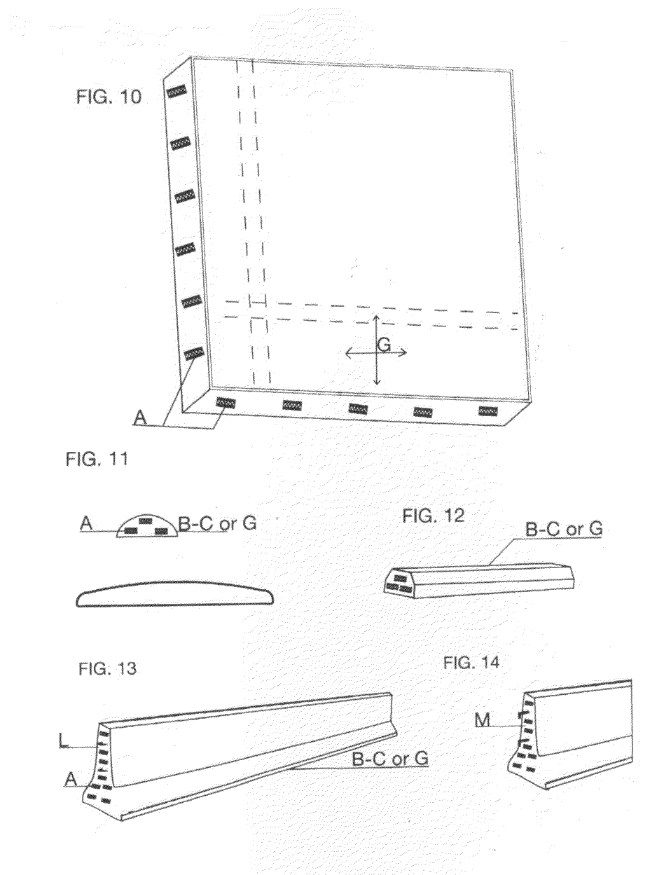

FIG. 10 shows a top and side view of a foundation, driveway, or a patio slab wherein Waste reinforced steel belted tire strips are installed as reinforcement into concrete, to become a component of a building site. This same process could yield a tilt-up wall.

FIG. 11 shows an end and side view of a speed bump, wherein Waste reinforced steel belted tire strips, or Waste reinforced fan belt strips, or Waste reinforced conveyor belt strips would be used as a reinforcement element, with the remainder of the component made up of Waste recycled thermoplastic, or virgin thermoplastic, or rubber, or concrete.

FIG. 12 shows an end view of a traffic divider or K-rail, wherein embodiment consist of Waste recycled thermoplastic, or virgin thermoplastic, or rubber, or concrete. This component will have an attachment device, either steel eye bolts or steel 90 degree anchor bolts or other attachment devices.

FIG. 13 shows a side view of FIG. 12

FIG. 14 shows an end and side view of a parking lot car stop wherein Waste reinforced steel belted tire strips, or Waste reinforced fan belt strips, or Waste reinforced conveyor belt strips would be used as a reinforcement element, with the remainder of the component made up of Waste recycled thermoplastic, or virgin thermoplastic, or rubber, or concrete.

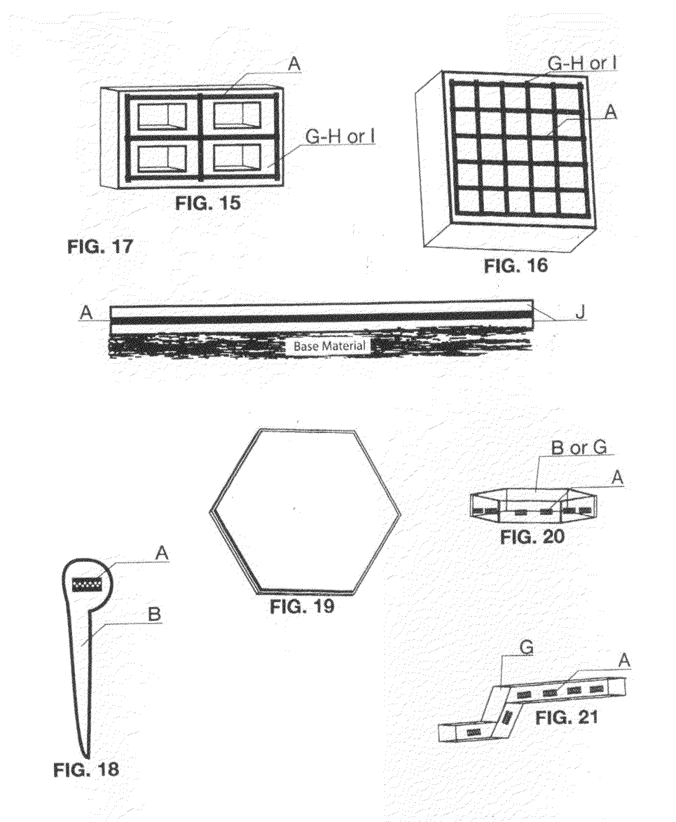

FIG. 15 shows a top view of a cinder block, wherein Waste reinforced steel belted tire strips, or Waste reinforced fan belt strips, or Waste reinforced conveyor belt strips would be used as a reinforcement element, with the remainder of the component made up of concrete, or cement, and or adobe.

FIG. 16 shows a side view of a flat block, wherein Waste reinforced steel belted tire strips, or Waste reinforced fan belt strips, or Waste reinforced conveyor belt strips would be used as a reinforcement element, with the remainder of the component made up of concrete, or cement, and adobe.

FIG. 17 shows a top cut view of an asphalt road constructed with Waste reinforced steel belted tire strips that are installed across the top layers as reinforcement into the asphalt, to become of the road component of a driveway, street, highway, or runway.

FIG. 18 shows a landscape border, to typically separate a lawn are from a garden area. This yard component would use Waste reinforced steel belted tire strips, or Waste reinforced fan belt strips, or Waste reinforced conveyor belt strips as a reinforcement element, with the remainder of the component made up of Waste recycled thermoplastic or virgin thermoplastic.

FIG. 19 shows a top view of a patio or yard stepping stone, wherein Waste reinforced steel belted tire strips, or Waste reinforced fan belt strips, or Waste reinforced conveyor belt strips would be used as a reinforcement element, with the remainder of the component made up of concrete, or Waste recycled thermoplastic

FIG. 20 shows an end view of FIG. 19

FIG. 21 shows a side cut view of a curb, gutter and sidewalk, wherein Waste reinforced steel belted tire strips, are used as the reinforcement element and the remainder of the curb, gutter and sidewalk component would consist of concrete.

I claim:

1. A method for manufacture of structural components from existing waste, used reinforced rubber tires; existing waste, used reinforced fan belts and existing waste, used reinforced conveyor belts and materials comprising; processing said waste, used reinforced rubber products, by mechanically cutting these items into strips approximately one quarter inch to twenty four inches in width; attaching cut strips end to end with a metal staples, or a bonding agent; selecting thermoplastics or rubber and processing said virgin or recycled thermoplastics or rubber in an extruder to compress and heat to form a molten mixture; disposing a reinforced element comprising of a singular or plurality of tire strips, fan belts strips, conveyor belt strips in a crosshead die attached to an extruder for forming a structural member as they are encapsulated and elongated; disposing a reinforced element comprising of a singular or plurality of tire strips, fan belts strips, or conveyor belt strips in a mold for forming a structural component; placing said molten mixture into said mold for forming said structural component; and removing from said mold after cooling has occurred said structural component.

2. The method as in claim 1 wherein said waste, used reinforced tires are selected from the group of waste, used car and truck tires from tire industries.

3. The method as in claim 1 wherein said waste, used fan belts are selected from various industries wanting to dispose of same.

4. The method as in claim 1 wherein said waste, used conveyor belts are selected from various industries wanting to dispose of same.

5. The method as in claim 1 wherein said thermoplastic is selected from the group of virgin and or recycled polyethylene and a polypropylene.

6. The method as in claim 1 wherein rubber is selected from a group of Neoprene rubber, Buna-n rubber, Viton rubber, Silicone rubber, Santoprene rubber or EPDM rubber.

7. The method as in claim 1 wherein said waste, used reinforced rubber products are mechanically cut into strips one quarter inch to twenty four inches in width.

8. The method as in claim 1 wherein said cut strips are attached end to end with a metal staples, or a bonding agent.

9. The method as in claim 1 wherein said reinforced elements are disposed into a crosshead die attached to an extruder with molten thermoplastic or molten rubber and are commingled and extruder there from.

10. The method as in claim 1 wherein said disposing of a single or multiple reinforced elements comprising of waste, used tire strips, waste, used fan belts strips, or waste, used conveyor belt strips, connected end to end, then disposed into a crosshead die attached to an extruder with molten thermoplastic or molten rubber to be commingled and shaped when exiting the crosshead die, to form an encapsulated reinforced cable, cable fencing, poles, post, boards, walls, blocks, underlayment and anchors.

11. The method as in claim 1 wherein said disposing of a single or multiple reinforced elements comprising of waste, used tire strips, waste, used fan belt strips, or waste, used conveyor belt strips, connected end to end then disposed and pretension into a mold for structural reinforcement. Thereafter you would inject into the mold the molten thermoplastic or molten rubber to obtain the desired structural component and remove after cooling has occurred.

12. The method as in claim 1 further comprising the adding of a fire retardant substance when the thermoplastics or rubber is put into the extruder hopper before the melting has occurred to obtain a good mixture.

13. The method as in claim 1 further comprising the adding of an ultraviolet protection material when the thermoplastics or rubber is put into the extruder hopper before melting has occurred to obtain a good mixture.

14. The method as in claim 1 further comprising the adding of baking soda in small amount, less than 2% of the weight of the thermoplastics to be added into the extruder hopper before melting has occurred to obtain a good mixture.

15. The method as in claim 1 wherein said extruder heats said mixture to approximately a temperature of 110 centigrade too 260 degrees centigrade.

16. A structural component produced according to the method of claim 1.

17. A method for manufacture of reinforced structural components from existing waste, used reinforced tires; existing waste, used reinforced fan belts; existing waste, used reinforced conveyor belts; concrete; cement; adobe; and materials comprising; processing said waste, used reinforced rubber products, by mechanically cutting these items into strips approximately one quarter inch too two inches in width; attaching cut strips end to end with a metal staples, or a bonding agent; disposing a reinforcement element into forms, or molds said elements are for reinforcement; selecting desired concrete, and or cement or adobe and processing said dry material with water to obtain a mud mixture; pour mud mixture into forms, or molds for forming said structural components; and removing forms after drying has occurred or removing from said mold after drying has occurred said structural components.

18. A structural component produced according to the method of claim 17.

19. A method for manufacture of reinforced structural component from existing waste, used reinforced tires; existing waste, used reinforced fan belts; existing waste, used reinforced conveyor belts; processing said waste, used reinforced rubber products, by mechanically cutting these items into strips approximately one quarter inch to two inches in width; attaching cut strips end to end with a metal staples, or a bonding agent; disposing a reinforcement element within layers of asphalt, and when compacted creates a reinforced asphalt drive, highway or runway.

20. A structural component produced according to the method of claim 19.

21. A method for manufacture of reinforced structural component from existing waste, used reinforced tires; processing said waste, used reinforced rubber products, by mechanically cutting the sidewalls into a continues strip approximately one quarter inch to two inches in width; then mechanically punch holes in said strip one to twelve inches apart; cross cut said strips into smaller strips, one foot to one hundred foot long; insert “S” hooks into the desired punched holes or use other attachment devices; then use said reinforced tire ties as bungee cords to secure desired tie down items.

22. A structural component produced according to the method of claim 21.
